(19) United States
(12) Patent Application Publication
(10) Pub. No.: US 2011/0181535 A1
(43) Pub. Date: Jul. 28, 2011

(54) PORTABLE ELECTRONIC DEVICE AND METHOD OF CONTROLLING DEVICE

(75) Inventor: Masayuki Takayama, Kanagawa (JP)

(73) Assignee: KYOCERA CORPORATION, Kyoto (JP)

(21) Appl. No.: 13/014,843

(22) Filed: Jan. 27, 2011

(30) Foreign Application Priority Data
Jan. 27, 2010 (JP) 2010-016069

(51) Int. Cl. G06F 3/041; G09G 5/00

(52) U.S. Cl. 345/173; 345/156

(57) ABSTRACT

Provided is a portable electronic device capable of improving user-friendliness of the portable electronic device having an operation detecting unit capable of detecting an operation. The portable electronic device according to the present invention includes an operation detecting unit that detects an operation; and a controlling unit that adjusts an operation detection area for the operation detecting unit according to a content of the operation detected by the operation detecting unit.

### CROSS-REFERENCE TO RELATED APPLICATIONS

This application is based on and claims the benefit of priority from Japanese Patent Application No. 2010-016069, filed on 27 Jan. 2010, the content of which is incorporated herein by reference.

### BACKGROUND OF THE INVENTION

1. Field of the Invention

The present invention relates to a portable electronic device provided with an operation detecting unit capable of detecting an operation.

2. Related Art

A portable electronic device such as a mobile telephone is typically provided with an operation detecting unit capable of detecting an operation. In recent years, portable electronic devices that detect an operation using a touch panel have seen wide spread use as one example of such an electronic device. For example, some of mobile telephones, PDAs (Personal Digital Assistants), and the like have a configuration in which a transparent touch panel is provided on a display screen such as a liquid crystal panel, an operation detection area is set on this touch panel, and a predetermined action is performed when a user's finger or a stylus pen is brought into contact with the operation detection area (see Japanese Unexamined Patent Application Publication No. 2009-205303, for example).

### SUMMARY OF THE INVENTION

A further improvement in usability is desired for a portable electronic device having an operation detecting unit.

An object of the present invention is to improve the usability of the portable electronic device having an operation detecting unit capable of detecting an operation.

The present invention relates to a portable electronic device provided with: an operation detecting unit that detects an operation; and a controlling unit that adjusts an operation detection area for the operation detecting unit according to a content of the operation detected by the operation detecting unit.

Further, the present invention can be such that when the operation is detected by the operation detecting unit in which the operation detection area has been adjusted, the controlling unit reverts the operation detection area for the operation detecting unit to the operation detection area immediately before the adjustment.

Moreover, the present invention can be such that the operation detecting unit is one of a plurality of operation detecting units, and when adjusting the operation detection area for the operation detecting unit according to the content of the operation detected by the operation detecting unit, the controlling unit also adjusts an operation detection area for one of the operation detecting units that is adjacent to the adjusted operation detecting unit.

Furthermore, the present invention can be such that the operation detecting unit is one of a plurality of operation detecting units, and the controlling unit performs the adjustment by placing the operation detection areas for the adjacent operation detecting units apart from each other.

Further, the present invention can be such that the operation detecting unit is one of a plurality of operation detecting units, and when enlarging the operation detection areas for the adjacent operation detecting units according to the content of the operation detected by the operation detecting unit, the controlling unit enlarges the operation detection areas such that an enlargement factor in an adjoining direction of the operation detecting units becomes smaller than an enlargement factor in a direction different from the adjoining direction.

Moreover, the present invention can be further provided with: a display unit that displays the operation detection area, wherein the controlling unit adjusts the operation detection area for the operation detecting unit according to the content of the operation detected by the operation detecting unit, and displays the adjusted operation detection area in the display unit.

Furthermore, the present invention can be such that the operation detecting unit is a touch panel that detects a touch operation.

Further, the present invention can be such that the operation detecting unit includes a vowel section associated with vowels and a consonant section associated with consonants, and when performing a hiragana input according to an operation detected by one of the vowel section and the consonant section, and if the operation is detected by one of the vowel section and the consonant section, the controlling unit relatively enlarges the operation detection area corresponding to the other of the vowel section and the consonant section.

Moreover, the present invention can be such that the operation detecting unit includes a vowel section associated with vowels and a consonant section associated with consonants, and when performing a hiragana input according to an operation detected by one of the vowel section and the consonant section, and if the operation is detected by one of the vowel section and the consonant section, the controlling unit relatively reduces the operation detection area corresponding to the one of the vowel section and the consonant section.

Furthermore, the present invention can be further provided with: a first storage area that stores the content of the operation and the operation detection area for the operation detecting unit in association with each other, wherein when the operation is detected by the operation detecting unit, the controlling unit compares the detected content of the operation with the content of the operation stored in the first storage area, and if the detected content of the operation is identical with the content of the operation stored in the first storage area, the controlling unit adjusts the operation detection area for the operation detecting unit to be the operation detection area associated with the content of the operation stored in the first storage area.

Further, the present invention can be further provided with: a second storage area that stores a character and a conversion candidate for the character in association with each other, wherein when performing a character input according to the operation detected by the operation detecting unit, the controlling unit compares a character inputted by the operation detecting unit according to the operation with the character stored in the second storage area, and if the character inputted by the operation detecting unit according to the operation and the character stored in the second storage area are identical, the controlling unit adjusts the operation detection area for the operation detecting unit based on the conversion candidate associated with the inputted character stored in the second storage area.

Moreover, the present invention can be such that the operation detecting unit includes a specific character type section associated with a particular character type, and when the operation is detected by the specific character type section, the controlling unit relatively enlarges the operation detection area in the specific character type section.

Furthermore, the present invention can be such that the operation detecting unit includes a specific character type section associated with a particular character type and a different character type section associated with a different character type, and when the operation is detected by the specific character type section, the controlling unit relatively reduces the operation detection area in the different character type section.

According to the present invention, it is possible to improve usability of a portable electronic device having an operation detecting unit capable of detecting an operation.

### BRIEF DESCRIPTION OF THE DRAWINGS

FIG. 1A is an elevational view illustrating a mobile telephone 1 as a first embodiment of a portable electronic device according to the present invention;

FIG. 1B is a side view illustrating the mobile telephone 1 as the first embodiment of the portable electronic device according to the present invention;

FIG. 2 is a block diagram illustrating a functional configuration of the mobile telephone 1 of the first embodiment;

FIG. 3 is an enlarged elevational view illustrating a touch panel 3 according to the first embodiment;

FIG. 4 is an illustration of a state in which an operation detection area 32 for a virtual key 31 corresponding to “E” is enlarged from the state shown in FIG. 3;

FIG. 5 is an illustration of a state in which operation detection areas 32 for a part of virtual keys 31 are enlarged and operation detection areas 32 for the other part of the virtual keys 31 are reduced from the state shown in FIG. 3;

FIG. 6 is an illustration of a state in which a relation between the enlargement and the reduction of the operation detection areas 32 is reversed from the state shown in FIG. 5;

FIG. 7 is an illustration in which FIG. 7(A) to FIG. 7(C) respectively show states where sizes and positions of operation detection areas 32 for adjacent virtual keys 31 are changed;

FIG. 8 is an illustration of a state in which the operation detection area 32 for the virtual key 31 corresponding to “H” is enlarged from the state shown in FIG. 3;

FIG. 9 is an illustration of a state in which the operation detection areas 32 for the virtual keys 31 corresponding to “W”, “Y”, and “I” are enlarged from the state shown in FIG. 3;

FIG. 10 is an illustration of a state in which the operation detection area 32 for the virtual key 31 corresponding to “T” is enlarged from the state shown in FIG. 3;

FIG. 11 is an enlarged elevational view illustrating the touch panel 3 according to a second embodiment (corresponding to FIG. 3);

FIG. 12 is an illustration of a state in which the operation detection areas 32 for a part of the virtual keys 31 are reduced from the state shown in FIG. 11; and

FIG. 13 is a flowchart showing a behavior according to the embodiments.

### DETAILED DESCRIPTION OF THE INVENTION

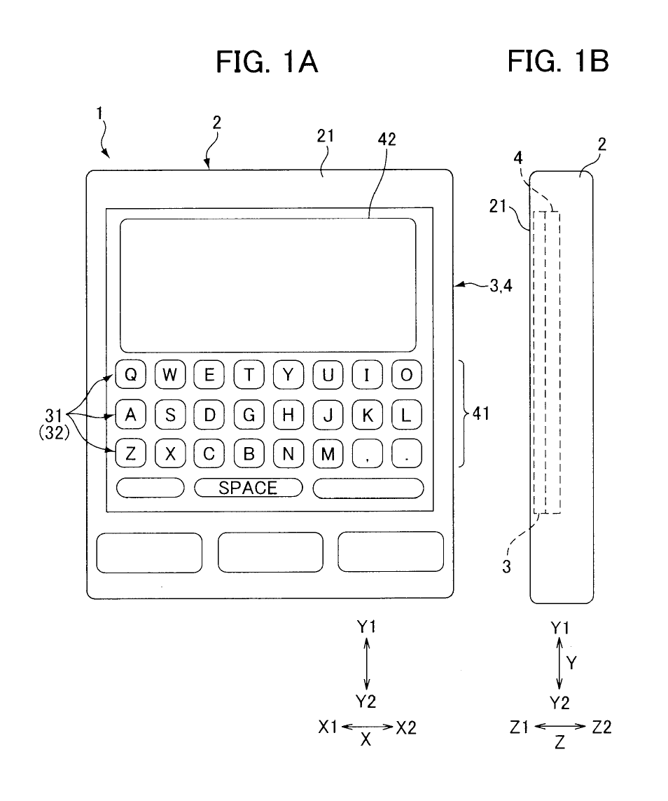

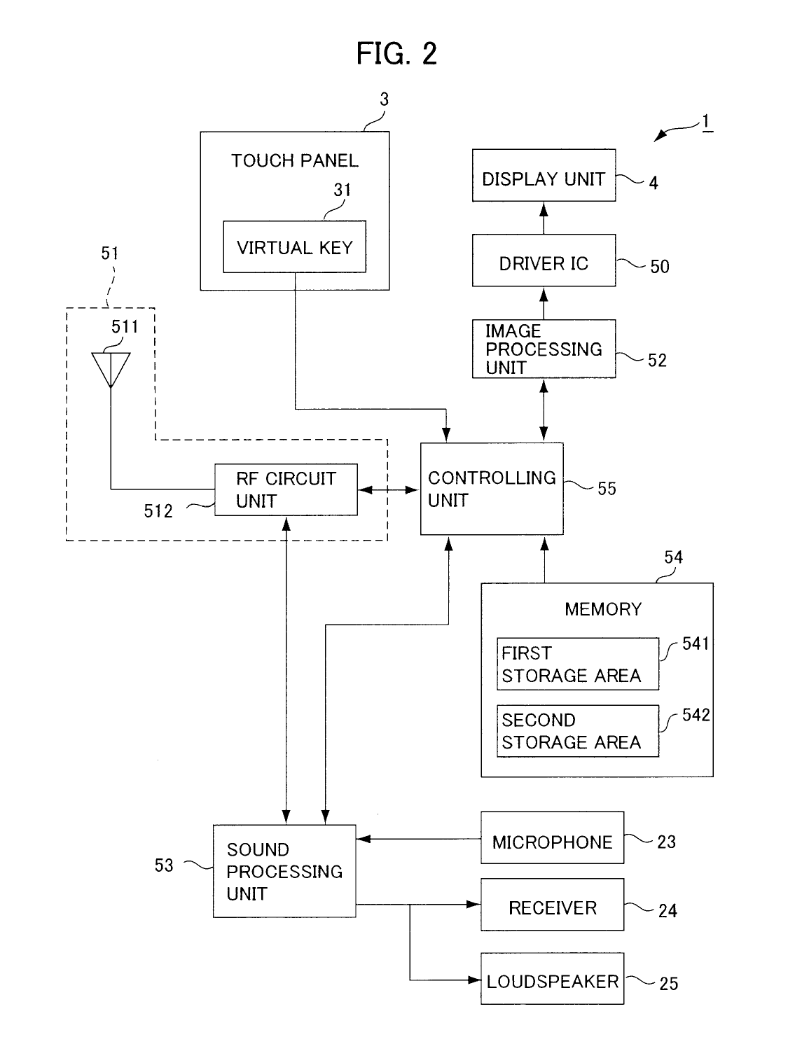

The following describes a first embodiment according to the present invention with reference to the drawings. First, a basic structure of a mobile telephone 1 as the first embodiment of a portable electronic device according to the present invention is described with reference to FIG. 1A and FIG. 1B. FIG. 1A is an elevational view illustrating the mobile telephone 1 as the first embodiment of the portable electronic device according to the present invention. FIG. 1B is a side view illustrating the mobile telephone 1 as the first embodiment of the portable electronic device according to the present invention. FIG. 2 is a block diagram illustrating a functional configuration of the mobile telephone 1 of the first embodiment.

Referring to FIG. 1A and FIG. 1B, the mobile telephone 1 of this embodiment is provided with a housing 2 that is formed into a rectangular flat box, a touch panel 3 having a plurality of operation detecting units, and a display unit 4. It should be noted that a right-left direction, an up-down direction, and a through-thickness direction in a frontal view shown in FIG. 1A are respectively represented by X, Y, and Z. Further, a leftward direction, a rightward direction, an upward direction, a downward direction, a frontward direction, and a backward direction are respectively represented by X1, X2, Y1, Y2, Z1, and Z2.

Referring to FIG. 1B, the display unit 4 is disposed within the housing 2, and faces outside from a side of a front surface (a side of the frontward direction Z1) of the housing 2. The display unit 4 displays various information (textual information and image information) such as a telephone number or a mail address of a person on the other end, and a content of the mail. The display unit 4 is constituted, for example, by a liquid crystal display, an organic EL (electroluminescence) display, or the like.

The mobile telephone 1 is able to execute various functional modes including, in addition to a telephone mode, a mail mode, a camera mode, the Internet mode, and the like. The display unit 4 displays an image corresponding to a functional mode that is executed.

FIG. 1A schematically shows an example of a display in the mail mode. In the mail mode, predetermined internal processing is executed, and the display unit 4 displays images of a full keyboard 41 and a mail information display screen 42. These images are a display (images) that corresponds to operation detection areas 32 for virtual keys 31 on the touch panel 3 that will be described later. Characters, numbers, symbols, and the like inputted via the full keyboard 41 are displayed on the mail information display screen 42 according to a user operation detected through the virtual keys 31 on the touch panel 3.

Further, by execution of predetermined internal processing, the display unit 4 displays various information (textual information and image information) such as a telephone number or a mail address of a person on the other end, and a content of the mail.

It should be noted that, in a functional mode other than the mail mode, keys, a display screen, and the like are changed according to the functional mode.

The touch panel 3 is disposed on a side of a front surface of the display unit 4 (a side of the front surface 21 of the housing 2). The touch panel 3 is transparent, and therefore the display unit 4 can be visually seen through the touch panel 3 from the side of the front surface 21 of the housing 2.

The touch panel 3 is a static touch sensor, and has a configuration in which a countless number of detecting elements are arranged in a matrix, for example. It should be noted that it is possible to use a static touch sensor having a structure different from this as the touch panel 3. Based on a detection signal from the touch panel 3, it is possible to detect a position at which the user has touched (input coordinate) and an area of a touched portion on a detection plane.

The touch panel 3 is partitioned into a plurality of predetermined coverages, each coverage being for each content of a behavior (hereinafter also referred to as the “behavior content”) executed by a controlling unit 55 (execution of an application or an input of characters) according to a touch operation by the user (hereinafter simply referred to as the “operation”). The plurality of virtual keys 31 are thus configured. In other words, the partitioned coverages respectively constitute the virtual keys 31 as the operation detecting units. It should be noted that a number of the partitioned coverages can be either one or more. The plurality of virtual keys 31 are in a so-called QWERTY arrangement, and FIG. 1A illustrates focusing on the alphabetical virtual keys 31 as the virtual keys 31, and the remaining ones of the virtual keys 31 such as number keys and symbol keys are not shown in the figure.

It should be noted that a transparent protective sheet or a protective panel can be provided on a side of a front surface of the touch panel 3. In this case, a surface of the protective sheet or the protective panel that faces outward is the detection plane for the user input. When the surface of the protective sheet or the protective panel is touched by the user, a detection signal that corresponds to the touched position is outputted from the touch panel 3 according to a change in an electrostatic capacitance.

Each of the virtual keys 31 on the touch panel 3 constitutes each key in the full keyboard 41. On the touch panel 3, the operation detection areas 32 are set so as to correspond to the virtual keys 31. The operation detection areas 32 are areas in the touch panel 3, and are set for the respective virtual keys 31 in order to accept a behavior content assigned to the corresponding virtual key 31.

The virtual keys 31 and the operation detection areas 32 are provided at a predetermined interval in their up, down, right, and left sides. Each virtual key 31 can be larger than or the same as the corresponding operation detection area 32. In the following, the description is given provided that each virtual key 31 is as large as the corresponding operation detection area 32.

According to the mobile telephone 1 of the first embodiment, a predetermined input behavior is taken by operating the operation detection area 32 set for the virtual key 31 on the touch panel 3 referring to a display of the virtual keys displayed in the display unit 4.

Further, in the housing 2, a microphone 23 (see FIG. 2), a receiver 24 (see FIG. 2), a loudspeaker 25 (see FIG. 2), and the like are disposed. The microphone 23 is used for inputting sound made by the user of the mobile telephone 1 during the call. The receiver 24 outputs sound made by the person on the other end. The loudspeaker 25 outputs sound for notifying of an incoming call to the mobile telephone 1, the sound made by the person on the other end, and the like.

It should be noted that the mobile telephone is not limited to the example as shown in FIG. 1A and FIG. 1B. For example, the mobile telephone can be a foldable mobile telephone provided with a display unit side housing having a touch panel and a display unit, an operating unit side housing having an operating unit, and a hinge unit that couples the display unit side housing and the operating unit side housing. Further, the mobile telephone can also be a slide mobile telephone in which the operating unit side housing and the display unit side housing are disposed one above the other and one of the housings is slidable in one direction in this state, can be a rotary type in which one of the housings is rotatable about an axial line along the disposed direction, or can also be such that the operating unit side housing and the display unit side housing are coupled via a two-axis hinge.

Next, a functional configuration of the mobile telephone 1 is described with reference to FIG. 2.

Referring to FIG. 2, the mobile telephone 1 is provided with the microphone 23, the display unit 4, the receiver 24, the loudspeaker 25, a driver IC 50, a communication unit 51, an image processing unit 52, a sound processing unit 53, a memory 54, and the controlling unit 55.

The communication unit 51 is provided with a main antenna 511 and an RF circuit unit 512, and communicates with a predetermined communication target. Examples of the communication target with which the communication unit 51 communicates include an external terminal device that performs transmission and reception of phone calls and mails with the mobile telephone 1, and an external device such as an external Web server to which the mobile telephone 1 connects via the Internet.

The main antenna 511 communicates with the external device in a predetermined usable frequency band.

The RF circuit unit 512 demodulates a signal received by the main antenna 511, and supplies the demodulated signal to the controlling unit 55. Further, the RF circuit unit 512 modulates a signal supplied from the controlling unit 55, and transmits the modulated signal to the external device (base station) via the main antenna 511.

The image processing unit 52 performs predetermined image processing according to the control of the controlling unit 55, and outputs the processed image data to the driver IC 50. The driver IC 50 stores the image data supplied from the image processing unit 52 in a frame memory (not depicted), and outputs the image data to the display unit 4 at a predetermined timing.

The sound processing unit 53 performs predetermined sound processing to the signal supplied from the RF circuit unit 512 according to the control of the controlling unit 55, and outputs the processed signal to the receiver 24, the loudspeaker 25, and the like. The receiver 24 and the loudspeaker 25 externally output the signal supplied from the sound processing unit 53.

Further, the sound processing unit 53 processes a signal inputted from the microphone 23 according to the control of the controlling unit 55, and outputs the processed signal to the RF circuit unit 512. The RF circuit unit 512 performs predetermined processing to the signal supplied from the sound processing unit 53, supplies the processed signal to the main antenna 511, and externally outputs the signal via the main antenna 511 as a radio wave.

The memory 54 includes, for example, a working memory, which is used in a computation process by the controlling unit 55. Further, the memory 54 stores data, tables, and such that are used by various applications running on the mobile telephone 1. For example, the memory 54 stores an address book, a mail DB in which electronic mails are stored, various dictionaries, information on the arrangement of the operation detection areas 32 for the virtual keys 31 corresponding to each functional mode, and the like. Moreover, the memory 54 is provided with a first storage area 541 and a second storage area 542. The first storage area 541 and the second storage area 542 will be described later in detail. It should be noted that the memory 54 can be a removable external memory.

The controlling unit 55 controls the mobile telephone 1 as a whole, and performs predetermined controls to the display unit 4, the communication unit 51, the image processing unit 52, the sound processing unit 53, and the like. Specific processes carried out by the controlling unit 55 will be described later.

The controlling unit 55 adjusts the operation detection areas 32 according to the content of the user operation detected by the operation detection area 32 for the virtual key 31 on the touch panel 3. Examples of “the adjustment of the operation detection areas 32” include, for example, enlarging areas of the specific operation detection areas 32, reducing areas of the specific operation detection areas 32, increasing an interval between the operation detection areas 32 for the adjacent virtual keys 31 (increasing a center-to-center spacing or end-to-end spacing), disabling the specific operation detection areas 32, and the like.

The controlling unit 55 adjusts the operation detection areas 32 for the virtual keys 31 according to the content of the operation detected by the virtual key 31, and displays the adjusted operation detection areas 32 on the display unit 4.

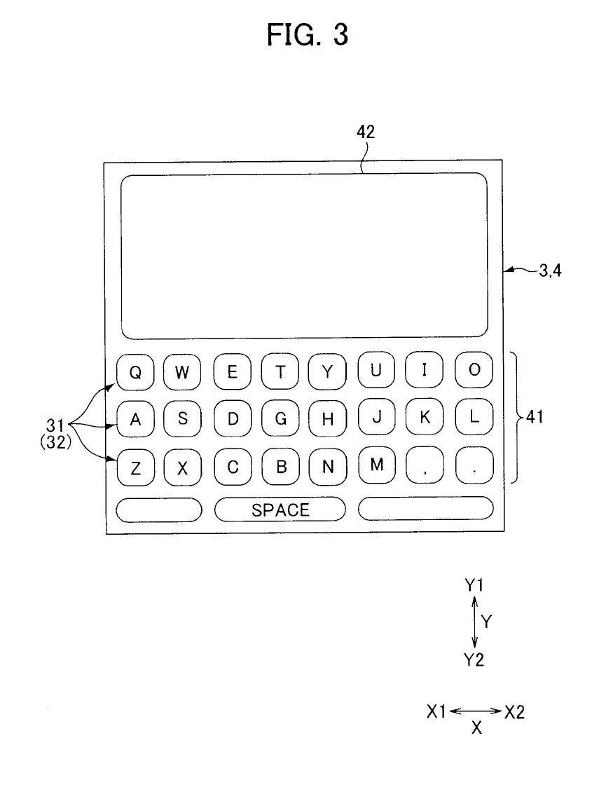

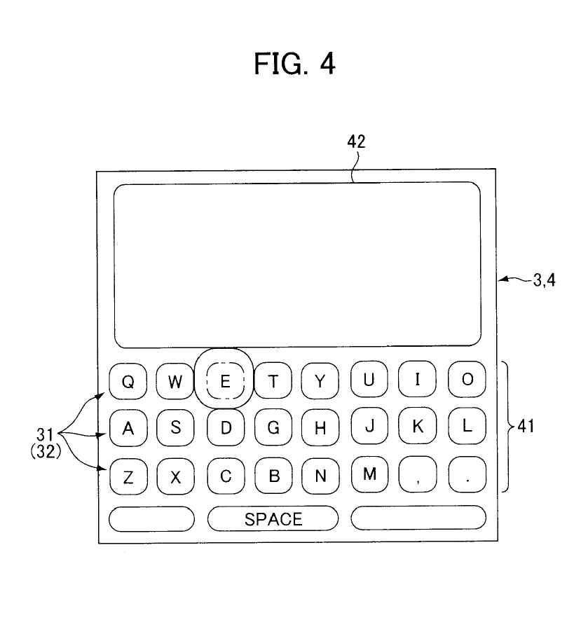

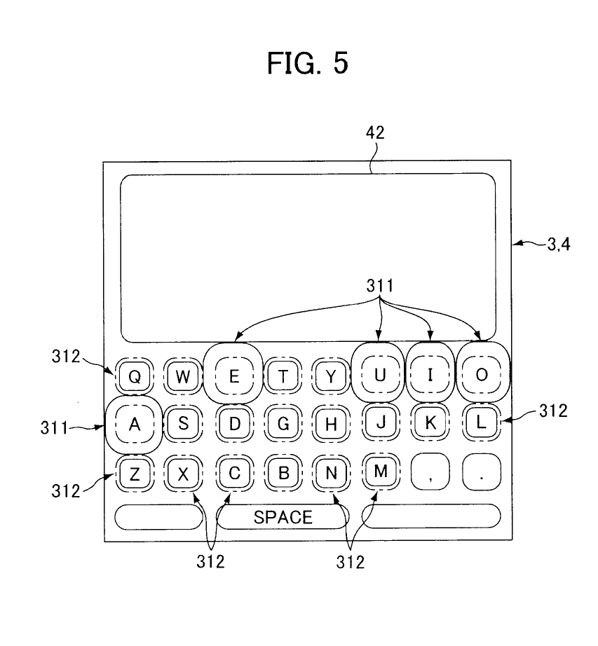

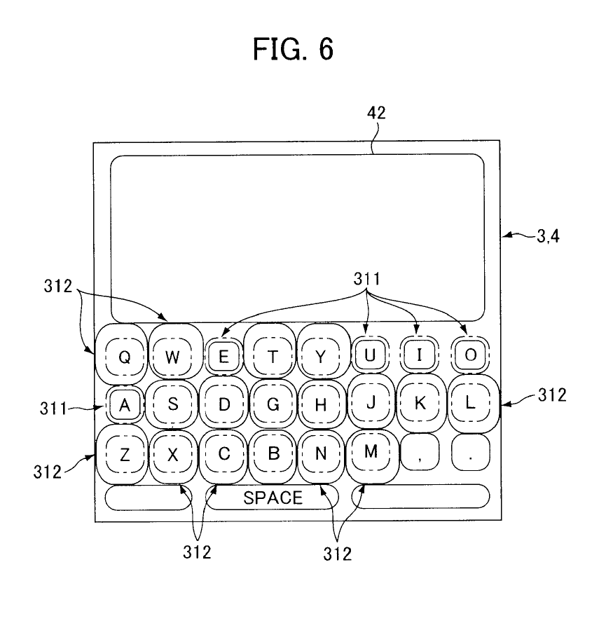

FIG. 3 is an enlarged elevational view illustrating the touch panel 3 according to the first embodiment. FIG. 4 is an illustration of a state in which the operation detection area 32 for the virtual key 31 corresponding to “E” is enlarged from the state shown in FIG. 3. FIG. 5 is an illustration of a state in which the operation detection areas 32 for a part of the virtual keys 31 are enlarged and the operation detection areas 32 for the other part of the virtual keys 31 are reduced from the state shown in FIG. 3. FIG. 6 is an illustration of a state in which a relation between the enlargement and the reduction of the operation detection areas 32 is reverted from the state shown in FIG. 5.

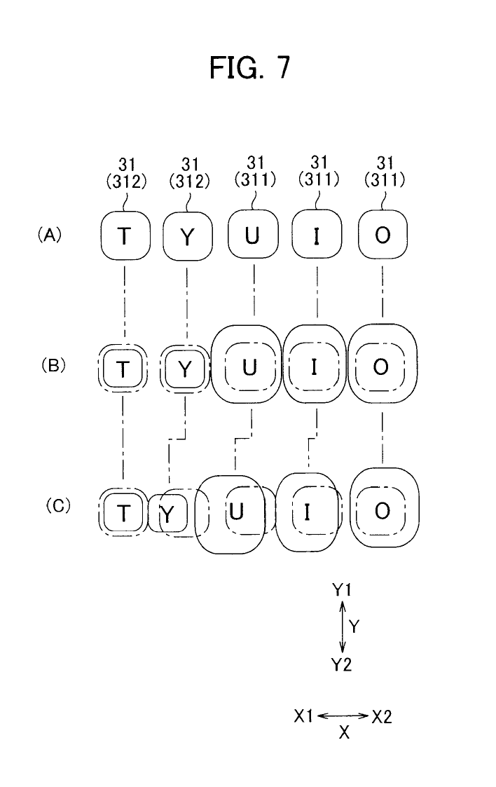

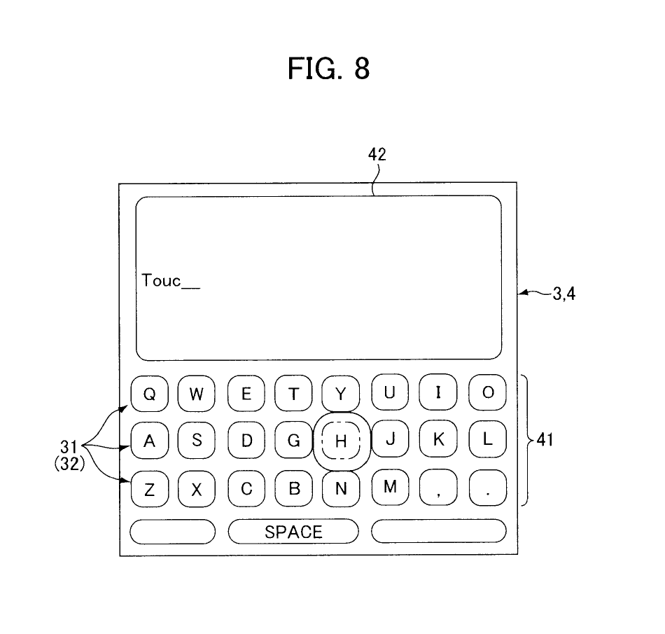

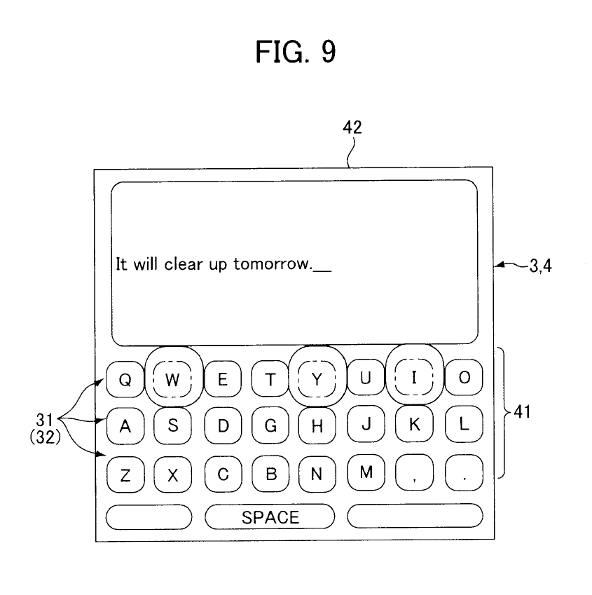

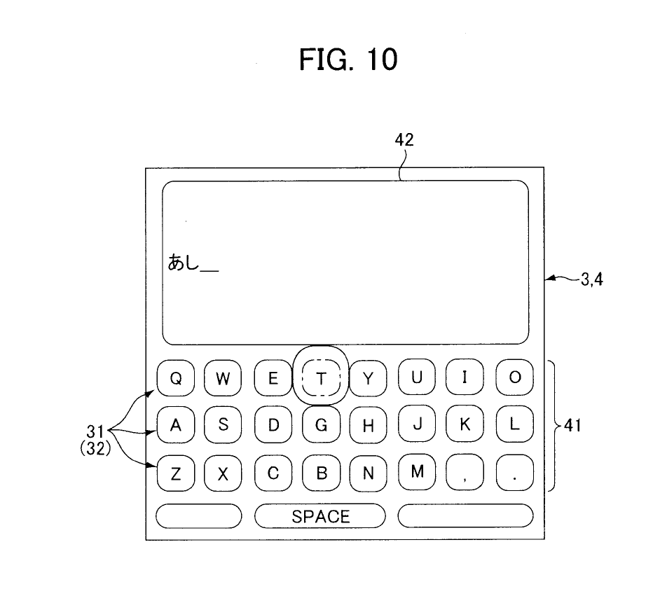

FIG. 7 is an illustration in which FIG. 7(A) to FIG. 7(C) respectively show states where sizes and positions of the operation detection areas 32 for the adjacent virtual keys 31 are changed. FIG. 8 is an illustration of a state in which the operation detection area 32 for the virtual key 31 corresponding to “H” is enlarged from the state shown in FIG. 3. FIG. 9 is an illustration of a state in which the operation detection areas 32 for the virtual keys 31 corresponding to “W”, “Y”, and “I” are enlarged from the state shown in FIG. 3. FIG. 10 is an illustration of a state in which the operation detection area 32 for the virtual key 31 corresponding to “T” is enlarged from the state shown in FIG. 3.

For example, when, as shown in FIG. 3, areas of all of the operation detection areas 32 for the virtual keys 31 (indicated by solid lines) are the same (a default state) for the plurality of virtual keys 31 that correspond to alphabets and the like, if the virtual key 31 corresponding to “E” is predicted to be a next input candidate, the controlling unit 55 enlarges the operation detection area 32 for the virtual key 31 corresponding to “E” as shown in FIG. 4.

It should be noted that an outline of each operation detection area 32 is indicated by a solid line when the size of the operation detection area 32 is default (see the virtual key 31 corresponding to “E” in FIG. 3). Further, when the size of the operation detection areas 32 is altered (enlarged or reduced) or the position of the operation detection areas 32 is altered, an outline of the operation detection area 32 of the default size and position is indicated by an alternate long and short dash line, and an outline of the operation detection area 32 after the alteration is indicated by a solid line (see the virtual key 31 corresponding to “E” in FIG. 4).

In a Japanese input mode (e.g., a romanized hiragana input mode), the operation detection areas 32 are adjusted (enlarged, reduced, or the like) based on the setting suitable for inputting Japanese. Further, in an English input mode, the operation detection areas 32 are adjusted (enlarged, reduced, or the like) based on the setting suitable for inputting English.

The following describes specific examples of “the adjustment of the operation detection areas 32”.

Referring to FIG. 5 and FIG. 6, the virtual keys 31 include a vowel section 311 associated with vowels (“A”, “I”, “U”, “E”, and “O”), and a consonant section 312 associated with consonants (the rest of the alphabets).

When performing the hiragana input according to an operation detected by the vowel section 311 or the consonant section 312, and if the operation is detected by one of the vowel section 311 and the consonant section 312, the controlling unit 55 is able to relatively enlarge the operation detection areas 32 corresponding to the other of the vowel section 311 and the consonant section 312.

For example, when performing the hiragana input in the romanized input mode, if the consonant section 312 is first pressed and the operation detection area 32 corresponding to the consonant section 312 is detected, it is highly possible that the virtual key 31 to be next pressed (operated) is in the vowel section 311. Accordingly, as shown in FIG. 5, the controlling unit 55 enlarges the operation detection areas 32 corresponding to the vowel section 311. Thereafter, if the vowel section 311 is pressed and the operation detection area 32 corresponding to the vowel section 311 is detected, it is highly possible that the virtual key 31 to be pressed (operated) next is in the consonant section 312. Accordingly, as shown in FIG. 6, the controlling unit 55 enlarges the operation detection areas 32 corresponding to the consonant section 312.

According to this embodiment, as each operation detection area 32 is as large as the corresponding virtual key 31, the virtual keys 31 are also enlarged and it is possible to positively lead the user to operate the enlarged virtual keys 31, thereby suppressing an erroneous input.

The description “relatively enlarge the operation detection areas 32 corresponding to the other of the vowel section 311 and the consonant section 312” means not only actually enlarging the operation detection areas 32 corresponding to the other section, but also relatively enlarging the operation detection areas 32 corresponding to the other section with respect to the operation detection areas 32 corresponding to the one section by actually reducing the operation detection areas 32 corresponding to the one section (without changing the areas of the operation detection areas 32 corresponding to the other section).

Further, when performing the hiragana input according to the operations detected by the vowel section 311 or the consonant section 312, and if the operation is detected by one of the vowel section 311 and the consonant section 312, the controlling unit 55 is able to relatively reduce the operation detection areas for the operations by one of the vowel section 311 and the consonant section 312.

For example, when performing the hiragana input in the romanized input mode, if the consonant section 312 is first pressed and the operation detection area 32 corresponding to the consonant section 312 is detected, it is highly probable that the virtual key 31 to be next pressed (operated) is in the vowel section 311. Accordingly, as shown in FIG. 5, the controlling unit 55 reduces the operation detection areas 32 corresponding to the consonant section 312. Thereafter, if the vowel section 311 is pressed and the operation detection area 32 corresponding to the vowel section 311 is detected, it is highly probable that the virtual key 31 to be next pressed (operated) is in the consonant section 312. Accordingly, as shown in FIG. 6, the controlling unit 55 reduces the operation detection areas 32 corresponding to the vowel section 311.

The description “relatively reduce the operation detection areas 32 corresponding to the other of the vowel section 311 and the consonant section 312” means not only actually reducing the operation detection areas 32 corresponding to the other section, but also relatively reducing the operation detection areas 32 corresponding to the other section with respect to the operation detection areas 32 corresponding to the one section by actually enlarging the operation detection areas 32 corresponding to the one section (without changing the area of the operation detection areas 32 corresponding to the other section).

Upon detection of the operation by the virtual key 31 for the adjusted operation detection area 32, the controlling unit 55 reverts the operation detection areas 32 for the virtual keys 31 to the operation detection areas 32 immediately before the adjustment.

For example, as shown in FIG. 4, if the operation is detected by the virtual key 31 corresponding to “E” when the operation detection area 32 for the virtual key 31 corresponding to “E” is enlarged, the size of the operation detection area 32 for the virtual key 31 corresponding to “E” is reverted to the default size.

When adjusting the operation detection areas 32 for the virtual keys 31 according to the content of the operation detected by the virtual key 31, the controlling unit 55 can adjust the operation detection areas 32 for the virtual keys 31 adjacent to the virtual keys 31 to be adjusted.

When adjusting the operation detection areas 32 for the virtual keys 31 adjacent to each other according to the content of the operation detected by the virtual key 31, the controlling unit 55 can make the operation detection areas 32 for the virtual keys 31 adjacent to each other spaced apart from each other.

When enlarging the operation detection areas 32 for at least three virtual keys 31 adjacent to each other according to the content of the operation detected by the virtual key 31, the controlling unit 55 can enlarge the operation detection areas 32 for the at least three virtual keys 31 adjacent to each other excluding the virtual keys 31 on the both ends such that an enlargement factor of the virtual keys 31 is smaller in an adjoining direction (right-left direction) X than in a direction (up-down direction) Y perpendicular to the adjoining direction X.

For example, as shown in FIG. 3, the three virtual keys 31 corresponding to “U”, “I”, and “O” to each other in the touch panel 3. Further, it is assumed that, when the consonant section 312 is pressed, the vowel section 311 is set to be enlarged and the consonant section 312 is set to be reduced as shown in FIG. 5. In this case, when the consonant section 312 is pressed, and if the vowel section 311 is enlarged as shown in FIG. 5 and the consonant section 312 is reduced, the three virtual keys 31 corresponding to “U”, “I”, and “O” that are in the vowel section 311 are enlarged. On a left side (X1 side) of the virtual key 31 corresponding to “U”, there is the virtual key 31 corresponding to “Y” that is in the consonant section 312, and therefore the virtual key 31 corresponding to “U” can be enlarged leftward. On a right side (X2 side) of the virtual key 31 corresponding to “O”, there is no virtual key 31, and therefore the virtual key 31 corresponding to “O” can be enlarged rightward.

However, the virtual key 31 corresponding to “I” is positioned between the virtual key 31 corresponding to “U” and the virtual key 31 corresponding to “O”. Accordingly, the virtual key 31 corresponding to “I” cannot be enlarged too much in the adjoining direction (right-left direction) X of the virtual keys 31. On the other hand, there is the mail information display screen 42 on a upward side (Y1 side) of the virtual key 31 corresponding to “I”, and there is the virtual key 31 corresponding to “K” in the consonant section 312 on a downward side (Y2 side) of the virtual key 31 corresponding to “I”. Accordingly, the virtual key 31 corresponding to “I” can be enlarged in the up-down direction Y (direction perpendicular to the adjoining direction X) of the virtual key 31 corresponding to “I” to an extent greater than in the adjoining direction (right-left direction) X. In other words, as shown in FIG. 7(A) and FIG. 7(B), the operation detection area 32 for the virtual key 31 corresponding to “I” can be enlarged such that the enlargement factor of the virtual key 31 is smaller in the adjoining direction (right-left direction) X than in the direction (up-down direction) Y perpendicular to the adjoining direction X.

It should be noted that, the direction whose enlargement factor is greater is not limited to the adjoining direction X or the perpendicular direction Y.

Further, in an example shown in FIG. 7(B), for the virtual keys 31 corresponding to “T” and “Y” in the consonant section 312, while the sizes are changed (reduced), the position (center position) is not changed (not moved).

On the other hand, when adjusting the operation detection areas 32 for the virtual keys 31 corresponding to “T”, “Y”, “U”, “I”, and “O” that are adjacent to each other, as shown in FIG. 7(C), the controlling unit 55 can enlarge intervals between the operation detection areas 32 for the virtual keys 31 corresponding to “U”, “I”, and “O” (intervals between the center positions or the end edges) by decreasing an interval between the operation detection areas 32 for the virtual keys 31 corresponding to “T” and “Y” (interval between the center positions or the end edges). With this, it is possible to make the operation detection areas 32 for the virtual keys 31 corresponding to “U”, “I”, and “O” spaced apart from each other while the areas of the operation detection areas 32 for the virtual keys 31 corresponding to “U”, “I”, and “O” are enlarged.

The memory 54 includes the first storage area 541 and the second storage area 542. The first storage area 541 is configured by a table, a database, and the like in which the content of the operation and the operation detection areas 32 for the virtual keys 31 are stored in association with each other.

When the operation is detected by the virtual key 31, the controlling unit 55 compares the detected content of the operation with the content of the operation stored in the first storage area 541. If the detected content of the operation is identical with the content of the operation stored in the first storage area 541, the controlling unit 55 adjusts the operation detection areas 32 for the virtual keys 31 such that the operation detection areas 32 are associated with the contents of the operation stored in the first storage area 541.

For example, combinations of characters “CH”, “TH”, and “ER” are relatively common among spelling of English words. Therefore, in an English input mode, the controlling unit 55 enlarges the operation detection area 32 corresponding to “H” as an input candidate when “C” is inputted, “H” as an input candidate when “T” is inputted, and “R” as an input candidate when “E” is inputted.

More specifically, after the virtual key 31 corresponding to “C” is inputted, it is highly probable that the virtual key 31 corresponding to “H” is pressed. Therefore, the first storage area 541 stores an operation for pressing “C” and an operation for pressing “H” in association. Then, when the virtual key 31 corresponding to “C” is inputted, the controlling unit 55 compares the content of the operation for pressing the virtual key 31 corresponding to “C” with the content of the operation for pressing the virtual key 31 corresponding to “C” stored in the first storage area 541. In this case, as the both contents of the operations are the same, the operation detection area 32 for the virtual key 31 corresponding to “H” is enlarged.

Specifically, in the English input mode, when the user attempts to input “Touch Panel” and at the time when the user has inputted “Touc”, the controlling unit 55 predicts “h” as a next input candidate as shown in FIG. 8, and enlarges the operation detection area 32 for the virtual key 31 corresponding to “H”.

Further, in the English input mode, when a space is inputted (pressed) after a period, the next inputted normally is the beginning of a sentence. Further, it is highly probable that the nominative is a personal pronoun. Therefore, the controlling unit 55 predicts beginning characters of “I”, “You”, “It”, and “We” (“I”, “Y”, and “W”) that are personal pronouns as the next input candidates, and enlarges the operation detection areas 32 for the virtual keys 31 corresponding to “I”, “Y”, and “W” as shown in FIG. 9.

The second storage area 542 stores characters and conversion candidates for the characters in association with each other. The conversion candidates include a conversion candidate of a normal process and a candidate by the predicted conversion.

When performing the character input according to the operation detected by the virtual key 31, the controlling unit 55 compares the character inputted by the virtual key 31 according to the operation with the character stored in the second storage area 542. If the character inputted by the virtual key 31 according to the operation and the character stored in the second storage area 542 are identical, the controlling unit 55 adjusts the operation detection areas 32 for the virtual keys 31 based on the conversion candidate stored in the second storage area 542 in association with the inputted character.

For example, in the romanized hiragana input mode, the second storage area 542 stores a predict conversion candidate “tomorrow” (=“A”, “S”, “I”, “T”, and “A”) for a case in which “A”, “S”, and “I” are inputted in this order.

Then, as shown in FIG. 10, in the romanized hiragana input mode, at the time point when “A”, “S”, and “I” are inputted in this order, the controlling unit 55 compares the characters “A”, “S”, and “I” that are inputted by the virtual keys 31 according to the operation with the characters “A”, “S”, and “I” stored in the second storage area 542. In this case, as the both characters are identical, the controlling unit 55 predicts a word to be converted is “tomorrow”, and enlarges the operation detection area 32 for the virtual key 31 corresponding to “T” that is to be inputted.

In this manner, it is possible to enlarge the operation detection areas 32 for the virtual keys 31 corresponding to the characters that are possibly next needed for the user in combination with a word predicting function provided for the controlling unit 55 and the memory 54.

Further, by storing spells of frequently-inputted words for the user in a user dictionary of the memory 54, the controlling unit 55 can enlarge the operation detection areas 32 according to the spells of the stored words.

Next, a second embodiment according to the present invention is described. The second embodiment is described mainly in its differences from the first embodiment, and like components as those in the first embodiment are denoted by like reference symbols, and explanations thereof are omitted. The descriptions for the first embodiment are appropriately applied to portions in the second embodiment that are not particularly described.

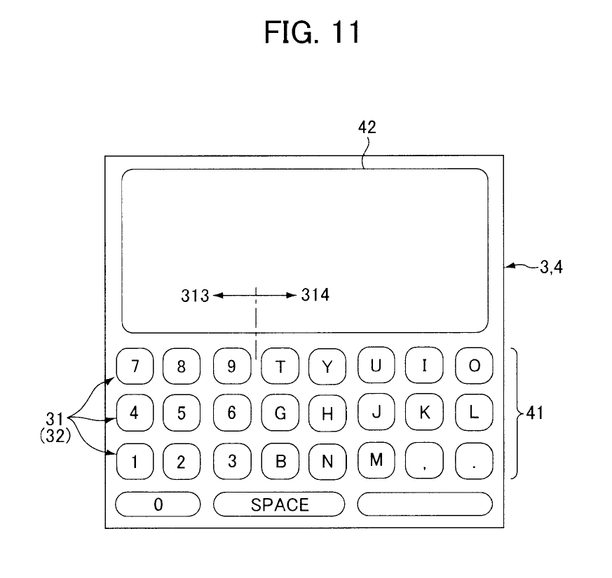

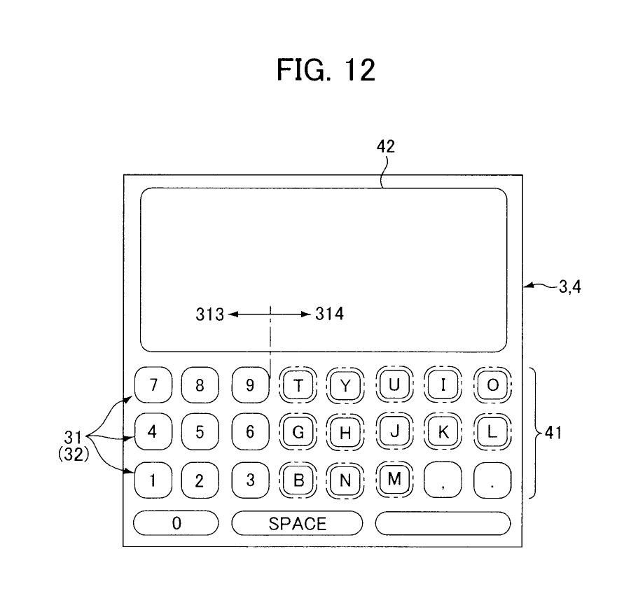

FIG. 11 is an enlarged elevational view illustrating the touch panel 3 according to the second embodiment (corresponding to FIG. 3). FIG. 12 is an illustration of a state in which the operation detection areas 32 for a part of virtual keys 31 are reduced from the state shown in FIG. 11.

As shown in FIG. 11 and FIG. 12, a mobile telephone 1A according to the second embodiment is different from the mobile telephone 1 according to the first embodiment in that the virtual keys 31 for numbers (“0” to “9”) are disposed on a left side of the full keyboard 41. Other configurations are the same as that of the first embodiment.

The following describes characteristic features of the second embodiment in detail.

The virtual keys 31 include a specific character type section 313 associated with a particular character type and a different character type section 314 associated with another character type.

The specific character type section 313 according to the second embodiment is for the virtual keys 31 of the numbers. The different character type section 314 according to the second embodiment is for the virtual keys 31 of the alphabets.

When the operation is detected by the specific character type section 313, the controlling unit 55 relatively enlarges the operation detection areas 32 in the specific character type section 313. Further, when the operation is detected by the specific character type section 313, the controlling unit 55 relatively reduces the operation detection areas 32 in the different character type section 314.

The description “relatively enlarges the operation detection areas 32 in the specific character type section 313” means not only actually enlarging the operation detection areas 32 in the specific character type section 313, but also relatively enlarging the operation detection areas 32 in the specific character type section 313 with respect to the operation detection areas 32 in the different character type section 314 by actually reducing the operation detection areas 32 in the different character type section 314 (without changing the area of the operation detection areas 32 in the specific character type section 313).

The description “relatively reduces the operation detection areas 32 in the different character type section 314” means not only actually reducing the operation detection areas 32 in the different character type section 314, but also relatively reducing the operation detection areas 32 in the different character type section 314 with respect to the operation detection areas 32 in the specific character type section 313 by actually enlarging the operation detection areas 32 in the specific character type section 313 (without changing the area of the operation detection areas 32 in the different character type section 314).

Specifically, when the number virtual key 31 in the specific character type section 313 is first pressed, it is highly probable that the number virtual key 31 in the specific character type section 313 is subsequently pressed. Therefore, as shown in FIG. 12, when the operation of pressing the number virtual key 31 in the specific character type section 313 is detected, the controlling unit 55 reduces the operation detection areas 32 for the alphabetical virtual keys 31 in the different character type section 314 while maintaining the operation detection areas 32 for the virtual keys 31 as default. With this, it is possible to relatively enlarge the operation detection areas 32 for the number virtual keys 31 in the specific character type section 313.

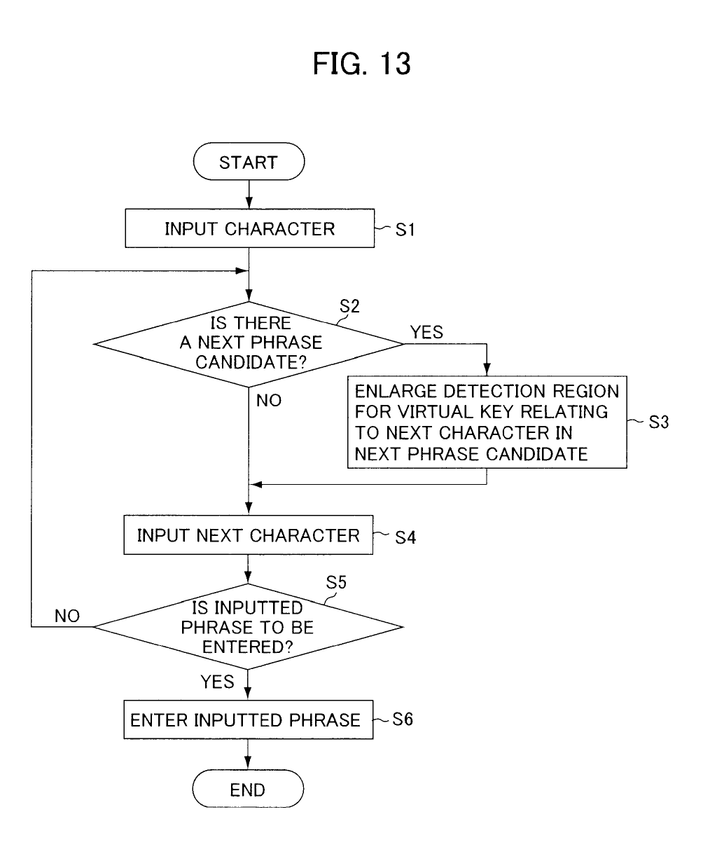

Next, a representative behavior in the first embodiment and the second embodiment is described. FIG. 13 is a flowchart showing a behavior according to the embodiments. This processing is performed continuously until an application relating to the character input screen such as the mail application is terminated.

In Step S1, when the user operates the virtual keys 31 (character input), the controlling unit 55 accepts the operation of the virtual keys 31.

In Step S2, the controlling unit 55 refers to the memory 54 as needed based on the accepted operation, and selects a candidate for a phrase that is highly probably (predicted to be) operated next (also referred to as the “next phrase candidate”). If the next phrase candidate is selected (YES), the process proceeds to Step S3. If the next phrase candidate is not selected (NO), the process proceeds to Step S4.

In Step S3, the controlling unit 55 enlarges the operation detection areas 32 for the virtual keys 31 relating to next characters in the next phrase candidate. Then, the process proceeds to Step S4.

In Step S4, when the user operates the next virtual keys 31 (character input), the controlling unit 55 accepts the operation of the next virtual keys 31.

In Step S5, the controlling unit 55 determines whether or not the inputted phrase is entered. Whether or not the inputted phrase is entered is determined based on an enter operation of the phrase and the like by the user.

If the controlling unit 55 determines that the inputted phrase is entered, the process proceeds to Step S6. On the other hand, if the controlling unit 55 determines that the inputted phrase is not entered, the process returns to Step S2.

In Step S6, the phrase that is inputted is entered, and the operation of the virtual keys 31 by the user, that is, the input behavior of the character is completed.

According to the mobile telephone 1 of the embodiments, the following effects are provided, for example.

The mobile telephone 1 of the embodiments is provided with the virtual keys 31 for detecting the operation, and the controlling unit 55 that adjusts the operation detection areas 32 for the virtual keys 31 according to the content of the operation detected by the virtual key 31. Therefore, according to the mobile telephone 1 of the embodiments, it is possible to cause the desired virtual key 31 to detect the operation easily, to suppress an erroneous input and the like by the user, and to improve the typing speed. Accordingly, it is possible to improve usability for the user.

According to the embodiments, when the operation is detected by the virtual key 31 for the adjusted operation detection areas 32, the controlling unit 55 reverts the operation detection areas 32 for the virtual keys to the operation detection areas 32 immediately before the adjustment. Therefore, it is possible to suppress unnecessary adjustment to the operation detection areas 32, and as a result, to improve usability for the user.

According to the embodiments, when adjusting the operation detection areas 32 for the virtual keys 31 according to the content of the operation detected by the virtual key 31, the controlling unit 55 also adjusts the operation detection areas 32 for the virtual keys 31 that are adjacent to the adjusted virtual keys 31. Therefore, according to the embodiments, by reducing the operation detection areas 32 for the adjacent virtual keys 31 when enlarging the operation detection areas 32 for certain virtual keys 31, for example, it is possible to prevent the interval between the operation detection areas 32 for the adjacent virtual keys 31 from becoming too small (becoming too close to each other), as well as to suppress the erroneous operation.

According to the embodiments, when adjusting the operation detection areas 32 for the virtual keys 31 that are adjacent to each other according to the content of the operation detected by the virtual key 31, the controlling unit 55 makes the operation detection areas 32 for the adjacent virtual keys 31 apart from each other. Therefore, according to the embodiments, it is possible to increase the interval between the operation detection areas 32 for the adjacent virtual keys 31, as well as to suppress the erroneous operation, as compared to a case in which the operation detection areas 32 for the adjacent virtual keys 31 are not apart from each other.

According to the embodiments, when enlarging the operation detection areas 32 for the virtual keys 31 that are adjacent to each other according to the content of the operation detected by the virtual key 31, the controlling unit 55 enlarges the operation detection areas 32 such that the enlargement factor in the direction Y perpendicular to the adjoining direction X is greater than the enlargement factor in the adjoining direction X. Therefore, according to the embodiments, it is possible to ensure the interval between the adjacent virtual keys 31, and reduce the possibility of the erroneous operation. It is also possible to enlarge the areas of the operation detection areas 32 for the adjacent virtual keys 31.

According to the embodiments, there is provided the display unit 4 on which the operation detection areas 32 are displayed, and the controlling unit 55 adjusts the operation detection areas 32 for the virtual keys 31 according to the content of the operation detected by the virtual key 31, and displays the adjusted operation detection areas 32 on the display unit 4. Therefore, according to the embodiments, it is possible for the user to visually see the sizes (areas) of the adjusted operation detection areas 32 easily, thereby improving the usability.

According to the embodiments, the virtual keys 31 include the partitioned coverages in the touch panel 3. Therefore, according to the embodiments, as compared to an operation detecting unit configured by hardware keys, it is possible to flexibly change the sizes (areas), the shapes (such as the aspect ratio), the arrangement (such as the center positions), and the like of the virtual keys 31 as the operation detecting units, thereby improving the usability.

According to the embodiments, the virtual keys 31 include the vowel section 311 associated with the vowels and the consonant section 312 associated with the consonants. When performing the hiragana input according to the operation detected by the vowel section 311 or the consonant section 312, and if the operation is detected by one of the vowel section 311 and the consonant section 312, the controlling unit 55 relatively enlarges the operation detection areas 32 corresponding to the other of the vowel section 311 and the consonant section 312. Further, according to the embodiments, when performing the hiragana input according to the operations detected by the vowel section 311 or the consonant section 312, and if the operation is detected by one of the vowel section 311 and the consonant section 312, the controlling unit 55 relatively reduces the operation detection areas for the operations by the one of the vowel section 311 and the consonant section 312.

Therefore, according to the embodiments, when performing the hiragana input in which a vowel and a consonant are usually inputted alternately, it is possible to input the virtual key 31 to be next pressed (operated) easily.

According to the embodiments, there is provided the first storage area 541 that stores the content of the operation and the operation detection areas 32 for the virtual keys 31 are stored in association with each other. When the operation is detected by the virtual keys 31, the controlling unit 55 compares the detected content of the operation with the content of the operation stored in the first storage area 541. If the detected content of the operation is identical with the content of the operation stored in the first storage area 541, the controlling unit 55 adjusts the operation detection areas 32 for the virtual keys 31 such that the operation detection areas 32 are associated with the content of the operation stored in the first storage area 541.

Therefore, according to the embodiments, it is possible to suppress the erroneous input and the like, thereby improving the usability.

According to the embodiments, there is provided the second storage area 542 that stores the characters and the conversion candidate for the characters in association with each other. When performing the character input according to the operation detected by the virtual key 31, the controlling unit 55 compares the character inputted by the virtual key 31 according to the operation with the character stored in the second storage area 542. If the character inputted by the virtual key 31 according to the operation and the character stored in the second storage area 542 are identical, the controlling unit 55 adjusts the operation detection areas 32 for the virtual keys 31 based on the conversion candidate stored in the second storage area 542 in association with the inputted character.

Therefore, according to the embodiments, it is possible to suppress the erroneous input and the like, thereby improving the usability.

According to the embodiments, the virtual keys 31 include a specific character type section 313 associated with a particular character type and a different character type section 314 associated with another character type. When the operation is detected by the specific character type section 313, the controlling unit 55 relatively enlarges the operation detection areas 32 in the specific character type section 313. Further, when the operation is detected by the specific character type section 313, the controlling unit 55 relatively reduces the operation detection areas 32 in the different character type section 314.

For example, the numbers are often inputted continuously. According to the embodiments, by relatively enlarging the number virtual keys 31 and relatively reducing the different virtual keys 31 in the different character type section 314 after the number virtual key 31 in the specific character type section 313 is pressed, it is possible to easily recognize the number virtual keys 31, and to easily input the number virtual keys 31 continuously.

As described above, the preferred embodiments according to the present invention have been described.

However, the present invention is not limited to the above embodiments, and can adopt various modifications. For example, according to the embodiments, the controlling unit 55 is configured to adjust the operation detection areas 32 for the virtual keys 31 according to the content of the operation detected by the virtual key 31, and displays the adjusted operation detection areas 32 on the display unit 4. However, the present invention is not limited to such an example.

For example, when operating the virtual key 31 to which a next phrase candidate that is actually frequently employed is assigned out of the next phrase candidates (including candidates predicted based on the word predicting function), the operation detection areas 32 are adjusted and displayed on the display unit 4. On the other hand, for a next phrase candidate that is actually less frequently employed is assigned, it is possible to process such that the adjusted operation detection areas 32 are not displayed on the display unit 4 or the operation detection areas 32 before the adjustment are displayed on the display unit 4, while the operation detection areas 32 are adjusted. With this, the user operation is lead to the virtual keys 31 for the characters relating to the next phrase candidates that are actually frequently employed (which are the adjusted operation detection areas 32 that are displayed and can be visually seen easily).

According to the embodiments, the operation detecting units are constituted by, but not limited to, the virtual keys 31 on the touch panel 3. For example, it is possible to configure the operating unit by hardware keys made of a synthetic resin and the like, and to configure the operation detecting units by a contact sensor capable of detecting the operation to the hardware keys. In the case of such a configuration, for example, when a key to be operated next is predicted to be “A”, it is possible to adjust the operation detection area for the operation detecting unit by assigning “A” to a key to which “A” is not assigned by default (key assign).

According to the embodiments, the portable electronic device according to the present invention is applied to the mobile telephone. However, the present invention is not limited to such an example. The present invention can be applied for, for example, various portable electronic devices including PHSs (registered trademark: Personal Handy phone Systems), portable gaming machines, portable navigation devices, PDAs (Personal Digital Assistants), notebook computers, and the like.

What is claimed is:

1. A portable electronic device, comprising:
an operation detecting unit that detects an operation; and
a controlling unit that adjusts an operation detection area for the operation detecting unit according to a content of the operation detected by the operation detecting unit.

2. The portable electronic device according to claim 1, wherein
when the operation is detected toward the operation detection area for the operation detecting unit which has been adjusted, the controlling unit reverts the operation detection area for the operation detecting unit to the operation detection area immediately before the adjustment.

3. The portable electronic device according to claim 1, wherein
the operation detecting unit is one of a plurality of operation detecting units, and
when adjusting the operation detection area for the operation detecting unit according to the content of the operation detected by the operation detecting unit, the controlling unit also adjusts an operation detection area for one of the operation detecting units that is adjacent to the adjusted operation detecting unit.

4. The portable electronic device according to claim 1, wherein
the operation detecting unit is one of a plurality of operation detecting units, and
the controlling unit performs the adjustment by placing the operation detection areas for the adjacent operation detecting units apart from each other.

5. The portable electronic device according to claim 1, wherein
the operation detecting unit is one of a plurality of operation detecting units, and
when enlarging the operation detection areas for the adjacent operation detecting units according to the content of the operation detected by the operation detecting unit, the controlling unit enlarges the operation detection areas such that an enlargement factor in an adjoining direction of the operation detecting units becomes smaller than an enlargement factor in a direction different from the adjoining direction.

6. The portable electronic device according to claim 1, further comprising:
a display unit that displays the operation detection area, wherein
the controlling unit adjusts the operation detection area for the operation detecting unit according to the content of the operation detected by the operation detecting unit, and displays the adjusted operation detection area in the display unit.

7. The portable electronic device according to claim 1, wherein
the operation detecting unit is a touch panel that detects a touch operation.

8. The portable electronic device according to claim 1, wherein
the operation detecting unit includes a vowel section associated with vowels and a consonant section associated with consonants, and
when performing a hiragana input according to an operation detected by one of the vowel section and the consonant section, and if the operation is detected by one of the vowel section and the consonant section, the controlling unit relatively enlarges the operation detection area corresponding to the other of the vowel section and the consonant section.

9. The portable electronic device according to claim 1, wherein
the operation detecting unit includes a vowel section associated with vowels and a consonant section associated with consonants, and
when performing a hiragana input according to an operation detected by one of the vowel section and the consonant section, and if the operation is detected by one of the vowel section and the consonant section, the controlling unit relatively reduces the operation detection area corresponding to the one of the vowel section and the consonant section.

10. The portable electronic device according to claim 1, further comprising:
a first storage area that stores the content of the operation and the operation detection area for the operation detecting unit in association with each other, wherein
when the operation is detected by the operation detecting unit, the controlling unit compares the detected content of the operation with the content of the operation stored in the first storage area, and
if the detected content of the operation is identical with the content of the operation stored in the first storage area, the controlling unit adjusts the operation detection area for the operation detecting unit to be the operation detection area associated with the content of the operation stored in the first storage area.

11. The portable electronic device according to claim 1, further comprising:
a second storage area that stores a character and a conversion candidate for the character in association with each other, wherein
when performing a character input according to the operation detected by the operation detecting unit, the controlling unit compares a character inputted by the operation detecting unit according to the operation with the character stored in the second storage area, and
if the character inputted by the operation detecting unit according to the operation and the character stored in the second storage area are identical, the controlling unit adjusts the operation detection area for the operation detecting unit based on the conversion candidate associated with the inputted character stored in the second storage area.

12. The portable electronic device according to claim 1, wherein
the operation detecting unit includes a specific character type section associated with a particular character type, and
when the operation is detected by the specific character type section, the controlling unit relatively enlarges the operation detection area in the specific character type section.

13. The portable electronic device according to claim 1, wherein
the operation detecting unit includes a specific character type section associated with a particular character type and a different character type section associated with a different character type, and
when the operation is detected by the specific character type section, the controlling unit relatively reduces the operation detection area in the different character type section.

14. A method of controlling a portable electronic device having an operation detection area in the portable electronic device provided with an operation detecting unit, the method comprising:
a detecting step of detecting an operation by the operation detecting unit;
an adjusting step of adjusting the operation detection area for the operation detecting unit according to a content of an operation detected by the operation detecting unit.

15. The method according to claim 14, wherein
when the operation is detected toward the operation detection area for the operation detecting unit which has been adjusted, the operation detection area for the operation detecting unit is reverted to the operation detection area immediately before performing the adjusting step.

16. The method according to claim 14, wherein
the operation detecting unit is one of a plurality of operation detecting units, and
an operation detection area for one of the operation detecting units that is adjacent to an operation detecting unit adjusted by the adjusting step is also adjusted while the adjusting step is performed.

17. The method according to claim 14, wherein
the operation detecting unit is one of a plurality of operation detecting units, and
the adjusting step is performed by placing the operation detection areas for the adjacent operation detecting units apart from each other.

18. The method according to claim 14, wherein
the operation detecting unit is one of a plurality of operation detecting units, and
when enlarging the operation detection areas for the adjacent operation detecting units according to the content of the operation detected by the operation detecting unit during the adjusting step, the operation detection areas are enlarged such that an enlargement factor in an adjoining direction of the operation detecting units becomes smaller than an enlargement factor in a direction different from the adjoining direction.

19. The method according to claim 14, wherein
the portable electronic device further comprises a display unit that displays the operation detection area, and wherein
an operation detection area for the operation detecting unit adjusted by the adjusting step is displayed in the display unit while the adjusting step is performed.
